(19) United States
(12) Patent Application Publication
(10) Pub. No.: US 2024/0396057 A1
(43) Pub. Date: Nov. 28, 2024

(54) Battery

(71) Applicant: Standard Energy Inc., Daejeon (KR)

(72) Inventors: Dongyoung Lee, Daejeon (KR); Sanghyun Park, Daejeon (KR)

(21) Appl. No.: 18/675,706

(22) Filed: May 28, 2024

(30) Foreign Application Priority Data
May 26, 2023 (KP) 1020230068421

(51) Int. Cl. H01M 8/0258; H01M 4/86; H01M 8/0247; H01M 8/04082; H01M 8/04186; H01M 8/18

(52) U.S. Cl. CPC H01M 8/0258; H01M 4/86; H01M 8/0247; H01M 8/04186; H01M 8/04201; H01M 8/188

(57) ABSTRACT

A battery can include a first liquid electrode to undergo a first half reaction; a second liquid electrode to undergo a second half reaction; a frame that forms a first electrode reservoir in which the first liquid electrode stored, and forms a second electrode reservoir in which the second liquid electrode stored; a separating membrane disposed between said first electrode reservoir and said second electrode reservoir; an inter-electrode through-hole formed at the frame in an out-of-plane direction; a first inter-electrode channel connecting the inter-electrode through-hole and the first electrode reservoir; and a second inter-electrode channel connecting the inter-electrode through-hole and the second electrode reservoir.

### CROSS-REFERENCE TO RELATED APPLICATION

This application claims priority to and the benefit of Korean Patent Application No. 10-2023-0068421, filed on May 26, 2023, the disclosure of which is incorporated herein by reference in its entirety.

### TECHNICAL FIELD

The present disclosure relates to a battery, more particularly, a battery in which a metal ion dissolved in an electrolyte is oxidized and reduced to charge or discharge the battery.

### BACKGROUND

Redox flow battery RFB is a system charged or discharged by oxidizing and reducing active materials in electrolytes, and the redox flow battery is operated by continuously circulating the electrolyte inside a stack using a fluid pump, where the actual electrochemical reaction occurs in the stack. While such the redox flow battery has advantages of long lifespan, high output and high capacity, there are problems of a large volume of the system and less flexibility in design due to a tank that stores the electrolyte and a fluid pump to flow the electrolyte. To address these problems, the inventors of the present invention developed a redox battery having no electrolyte tank and fluid pump. However, the crossover phenomenon that metal ions and water pass through a separator at a time of charge or discharge results in an imbalance of the electrolytes, deterioration in the performance of the battery and a reduction in the lifespan of the battery.

### SUMMARY

An objective of the present disclosure is to provide a battery in which an imbalance of liquid electrodes, caused by the crossover phenomenon, is resolved.

Aspects according to the present disclosure are not limited to the above ones, and other aspects and advantages that are not mentioned above can be clearly understood by one having ordinary skill in the art, based on the following description.

In one aspect, a battery according to an implementation can include a first liquid electrode to undergo a first half reaction; a second liquid electrode to undergo a second half reaction; a frame that forms a first electrode reservoir in which the first liquid electrode stored, and forms a second electrode reservoir in which the second liquid electrode stored; a separating membrane disposed between said first electrode reservoir and said second electrode reservoir; an inter-electrode through-hole formed at the frame in an out-of-plane direction; a first inter-electrode channel connecting the inter-electrode through-hole and the first electrode reservoir; and a second inter-electrode channel connecting the inter-electrode through-hole and the second electrode reservoir.

In another aspect, a battery according to an implementation can include a first current collector; a second current collector spaced apart from the first current collector; a separating membrane disposed between the first current collector and the second current collector; a frame that forms a first electrode reservoir between the first current collector and the separating membrane, and forms a second electrode reservoir between the second current collector and the separating membrane; an inter-electrode through-hole formed at the frame in the thickness direction of the frame; a first inter-electrode channel connecting the inter-electrode through-hole and the first electrode reservoir; and a second inter-electrode channel connecting the inter-electrode through-hole and the second electrode reservoir.

In another aspect, a battery according to an implementation can include a first liquid electrode to undergo a first half reaction; a second liquid electrode to undergo a second half reaction; a frame that forms a first electrode reservoir in which the first liquid electrode stored, and forms a second electrode reservoir in which the second liquid electrode stored; a separating membrane disposed between said first electrode reservoir and said second electrode reservoir; and an inter-electrode communication part that allows the first electrode reservoir and the second electrode reservoir to communicate with each other, wherein the portion, formed in a direction penetrating the plane formed by the separating membrane, of the inter-electrode communication part is disposed at the center of the inter-electrode communication part.

In another aspect, a battery according to an implementation can include a first liquid electrode to undergo a first half reaction; a second liquid electrode to undergo a second half reaction; a separating membrane disposed between the first liquid electrode and the second liquid electrode; a frame to support the separating membrane; and an inter-electrode communication part in which the first liquid electrode and/or the second liquid electrode flows, wherein the portion, formed in a direction penetrating the plane formed by the separating membrane, of the inter-electrode communication part is disposed at the center of the inter-electrode communication part.

Specific details of other implementations are described along with in the section of Detailed Description and Drawings.

The battery according to the present disclosure can have one or more of the following effects.

First, the inter-electrode communication part can be divided into substantially equal volumes based on the inter-electrode through-hole, which can have the advantage of smoothly balancing the amounts of first liquid electrode and the second liquid electrode.

Second, the inter-electrode communication part can be formed on the frame in a symmetrical arrangement around the center of the frame, which can have the advantage of uniformizing the strength of the frame.

Third, the inter-electrode communication part can have a bent part with an outer side that is protruding, which can have the advantage of suppressing the release of dissolved gas.

Fourth, a part of the frame that is disposed on the separator can be appropriately designed to prevent deformation of the frame and facilitate the movement of cations through the separator.

Specific effects are described along with the above-described effects in the section of Detailed Description.

Aspects according to the present disclosure are not limited to the above ones, and other aspects and advantages that are not mentioned above can be clearly understood from the following description and can be more clearly understood from the implementations set forth herein. Additionally, the aspects and advantages in the present disclosure can be realized via means and combinations thereof that are described in the appended claims.

### BRIEF DESCRIPTION OF DRAWINGS

FIG. 1 is an exploded perspective view of an example of a battery according to an implementation;

FIG. 2 is a perspective view of an example of a battery according to an implementation;

FIG. 3 is a cross sectional view of an example of the battery shown in FIG. 2 along a 3-3 direction;

FIG. 4 is a perspective view of an example of a battery module according to an implementation;

FIG. 5 is a plane view of an example of a frame according to an implementation;

FIG. 6 is a front view of an example of a frame according to an implementation;

FIG. 7 is a rear view of an example of a frame according to an implementation;

FIG. 8 is a transparent perspective view of a portion of an example of a frame according to an implementation;

FIG. 9 is a cross sectional view of an example of the frame shown in FIG. 8 along a 9-9 direction;

FIG. 10 is a structural diagram of an inter-electrode communication part according to an implementation;

FIG. 11 is a front view of an example of a frame according to another implementation;

FIG. 12 is a rear view of an example of a frame according to another implementation.

### DETAILED DESCRIPTION

The above-described aspects, features and advantages are specifically described hereunder with reference to the accompanying drawings such that one having ordinary skill in the art to which the present disclosure pertains can easily implement the embodiments introduced in the following disclosure. In the disclosure, detailed descriptions of known technologies in relation to the disclosure are omitted if they are deemed to make the understanding of the disclosure unnecessarily vague. Below, preferred embodiments according to the disclosure are specifically described with reference to the accompanying drawings. In the drawings, identical reference numerals can denote identical or similar components.

The terms “first”, “second” and the like are used herein only to distinguish one component from another component. Thus, the components should not be limited by the terms. Certainly, a first component can be a second component unless stated to the contrary.

Throughout the disclosure, each component can be provided as a single one or a plurality of ones, unless explicitly stated to the contrary.

Hereinafter, expressions of ‘a component is provided or disposed in an upper or lower portion’ may mean that the component is provided or disposed in contact with an upper surface or a lower surface. The present disclosure is not intended to limit that other elements are provided between the components and on the component or beneath the component.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Throughout the disclosure, the terms “A and/or B” as used herein can denote A, B or A and B, and the terms “C to D” can denote C or greater and D or less, unless stated to the contrary.

Hereinafter, referring to drawings for describe a battery according to embodiments of the present disclosure will be described.

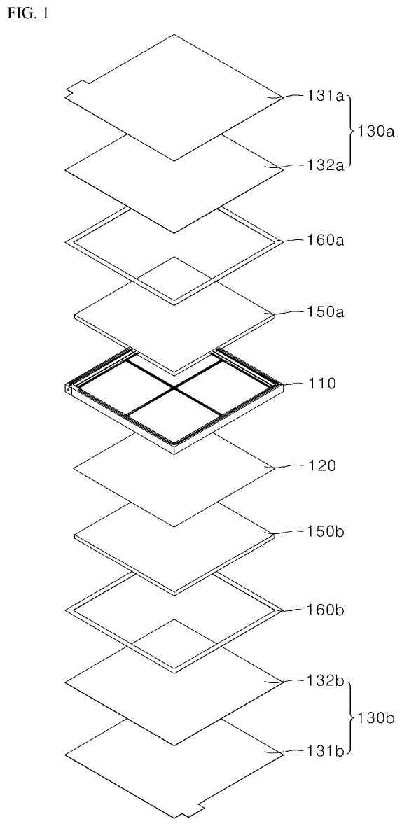

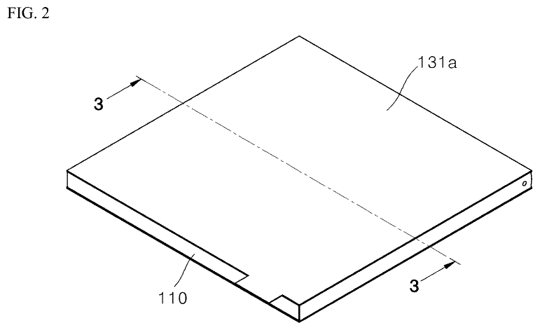

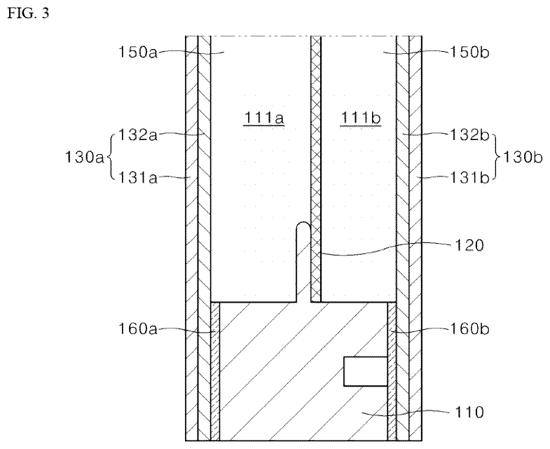

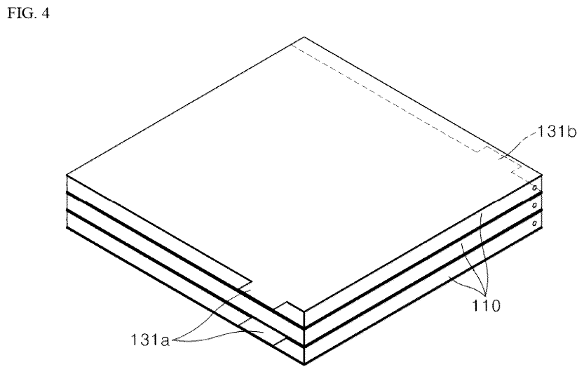

FIG. 1 is an exploded perspective view of an example of a battery according to an implementation. FIG. 2 is a perspective view of an example of a battery according to an implementation. FIG. 3 is a cross sectional view of an example of the battery shown in FIG. 2 along a 3-3 direction. FIG. 4 is a perspective view of an example of a battery module according to an implementation.

A battery according to some implementations can include a first current collector 130a; a second current collector 130b spaced apart from the first current collector 130a; a separating membrane 120 disposed between the first current collector 130a and the second current collector 130b; a frame 110 defining a first electrode reservoir 111a and a second electrode reservoir 111b; a first liquid electrode stored in the first electrode reservoir 111a and configured to undergo a first half reaction; a second liquid electrode stored in the second electrode reservoir 111b and configured to undergo a second half reaction; a first solid electrode 150a disposed in the first electrode reservoir 111a and impregnated with the first liquid electrode; a second solid electrode 150b disposed in the second electrode reservoir 111b and impregnated with the second liquid electrode; a first adhesive member 160a that provides a binding between the first current collector 130a and the frame 110 (e.g., that binds the first current collector 130a and the frame 110 directly or indirectly to each other); a second adhesive member 160b that provides a binding between the second current collector 130b and the frame 110 (e.g., that binds the second current collector 130b and the frame 110 directly or indirectly to each other).

The first liquid electrode is an electrolyte in which an anode redox couple is dissolved. The anode redox couple can be realized as a material including at least one of vanadium (V), zinc (Zn), bromine (Br), chromium (Cr), manganese (Mn), titanium (Ti), iron (Fe), cerium (Ce), and cobalt (Co), and in this implementation, it is a V²⁺/V³⁺ redox couple. The first liquid electrode can be an acidic aqueous solution that conducts electric current through ionization, and preferably contains sulfuric acid. In this implementation, the first liquid electrode can be manufactured in a way that vanadylsulfate (VOSO₄) or vanadium pentoxide (V₂O₅) is dissolved in a sulfuric acid (H₂SO₄) solution.

The first liquid electrode undergoes the first half reaction. The first half reaction is as follows, and ‘→’ represents the discharge reaction direction and ‘←’ represents the charge reaction direction.

V²⁺←→V³⁺+e⁻

When discharging, vanadium divalent ions are oxidized to vanadium trivalent ions. When charging, vanadium trivalent ions are reduced to vanadium divalent ions.

The first liquid electrode can be surrounded by the frame 110, the first current collector 130a and the separating membrane 120. The first liquid electrode can be prevented from flowing out in the plane direction between the first current collector 130a and the frame 110 by the first adhesive member 160a. Hereinafter, the in-plane direction refers to a direction parallel to the plane formed by the separating membrane 120. The first liquid electrode can be stored in the first electrode reservoir 111a. The first liquid electrode can be impregnated into the first solid electrode 150a.

The first liquid electrode can be electrically connected with the first current collector 130a so that an electron can move to the first current collector 130a when discharging and an electron of the first current collector 130a can move to the first liquid electrode. The first liquid electrode can become in contact with the separating membrane 120 so that a hydrogen cation (proton) is moved through the separating membrane 120.

The second liquid electrode is an electrolyte in which the cathode redox couple is dissolved. The cathode redox couple can be realized as a material including at least one of vanadium (V), zinc (Zn), bromine (Br), chromium (Cr), manganese (Mn), titanium (Ti), iron (Fe), cerium (Ce), and cobalt (Co), and in this implementation, it is a V⁴⁺/V⁵⁺ redox couple. The second liquid electrode can be an acidic aqueous solution that conducts electric current through ionization, and preferably contains sulfuric acid. In this implementation, the second liquid electrode can be manufactured in a way that vanadylsulfate (VOSO₄) or vanadium pentoxide (V₂O₅) is dissolved in a sulfuric acid (H₂SO₄) solution.

The second liquid electrode undergoes the second half reaction. The second half reaction is as follows, and ‘→’ represents the discharge reaction direction and ‘←’ represents the charge reaction direction.

V⁵⁺+e⁻←→V⁴⁺

When discharging, vanadium pentavalent ions are reduced to vanadium tetravalent ions. When charging, vanadium tetravalent ions are oxidized to vanadium pentavalent ions.

The second liquid electrode can be surrounded by the frame 110, the second current collector 130b and the separating membrane 120. The second liquid electrode can be prevented from flowing out in the plane direction between the second current collector 130b and the frame 110 by the second adhesive member 160b. The second liquid electrode can be stored in the second electrode reservoir 111b. The second liquid electrode can be impregnated into the second solid electrode 150b.

The second liquid electrode can be electrically connected with the second current collector 130b so that an electron can move to the second current collector 130b when charging and an electron of the second current collector 130b can move to the second liquid electrode. The second liquid electrode can become in contact with the separating membrane 120 so that a hydrogen cation (proton) is moved through the separating membrane 120.

As described above. The first liquid electrode and the second liquid electrode have the same component. The first liquid electrode and the second liquid electrode contain vanadium ions in an electrolyte of the same composition. Hereinafter, the first liquid electrode and the second liquid electrode are collectively referred to as liquid electrodes.

In some implementations, the frame 110 is formed as a square with a hollow interior region. According to other implementations, the frame 110 can be formed in a diamond, circle, triangle or polygon such as a pentagon, or other shapes. The frame can have a predetermined thickness in an out-of-plane direction to accommodate the first electrode reservoir 111a and the second electrode reservoir 111b. Hereinafter, the “out-of-plane” direction relative to a structure refers to a direction passing through the in-plane direction of the structure (where the “in-plane direction” is a direction parallel to the plane formed by the structure, such as separating membrane 120). The out-of-plane direction can include a through-thickness direction but in general is not limited to only to the direction perpendicular to the in-plane direction.

The first current collector 130a can be disposed in one side of the frame 110 and the second current collector 130b can be disposed in the other side of the frame 110 in the out-of-plane direction of the frame 110. The hollow interior region of the frame 110 can be enclosed by the first current collector 130a and the second current collector 130b. The frame 110 can be disposed between the first current collector 130a and the second current collector 130b, and can prevent the first liquid electrode and the second liquid electrode from flowing (e.g., leaking out) along the in-plane direction. According to the other implementations, a portion of the frame 110 may protrude outside of the first collector 130a or the second collector 130b. The frame 110 can be coupled to the first current collector 130a by the first adhesive member 160a and the second current collector 130b by the second adhesive member 160b.

The separating membrane 120 can be disposed in the hollow interior region of the frame 110. The hollow interior region of the frame 110 can be partitioned off into two spaces by the separating membrane 120. The frame 110 can be coupled to the separating membrane 120 by an adhesive member, which can be made of the same material as the first adhesive member 160a or the second adhesive member 160b.

The frame 110 can accommodate and form the first electrode reservoir 111a between the first current collector 130a and the separating membrane 120 and can accommodate and form the second electrode reservoir 111b between the second current collector 130b and the separating membrane 120.

The frame 110 can store the first liquid electrode and the second liquid electrode. The first solid electrode 150a and the second solid electrode 150b can be disposed inside the hollow interior region of the frame 110. The first adhesive member 160a can be adhered to an outer peripheral portion of the frame that faces the first current collector 130a and the second adhesive member 160b can be adhered to another outer peripheral portion of the frame 110 that faces the second current collector 130b, as shown in the example of FIG. 3.

The separating membrane 120 can be disposed on the frame 110 (e.g., in the hollow interior region of the frame 110) to separate the first liquid electrode and the second liquid electrode from each other, and can allow hydrogen cations (protons) to move between the first liquid electrode and the second liquid electrode. For example, as shown in FIG. 3, the separating membrane 120 can be disposed at the center of a thickness direction of the frame 110 inside the frame 110 to separate the first electrode reservoir 111a and the second electrode reservoir 111b.

The separating membrane 120 can be disposed between the first liquid electrode and the second liquid electrode. The separating membrane 120 can be disposed between the first current collector 130a and the second current collector 130b. The separating membrane 120 can be disposed further toward an interior region of the frame 110 (in the in-plane direction) as compared to the first adhesive member 160a or the second adhesive member 160b. An outer peripheral portion of the separating membrane 120 can be bonded to the frame 110.

When discharging, hydrogen cations pass through the separating membrane 120 and move from the first liquid electrode to the second liquid electrode. When charging, they pass through the separating membrane 120 and move from the second liquid electrode to the first liquid electrode.

The separating membrane 120 can include perfluorinated ionomer, partially fluorinated polymer, and non-fluorinated hydrocarbons. The separating membrane 120 can be formed of or include Nafion®, Flemion®, NEOSEPTA-F®, or Gore Select®.

The first current collector 130a can be disposed in one side of the frame 110 to form the first electrode reservoir 111a together with the frame 110 and the separating membrane 120. The first current collector 130a can be in parallel and spaced apart from the second current collector 130b. The first current collector 130a can be adhered to the first adhesive member 160a adhered to the frame 110. The first current collector 130a can be bonded to the frame 110 by the first adhesive member 160a. For example, the first adhesive member 160a can be applied or adhered to the outer peripheral portion of the first current collector 130a and/or to the peripheral region of the frame 110 to adhere the two together. The first current collector 130a can be electrically connected to the first liquid electrode and electrons can move so that current can flow when charging and discharging.

As shown in FIG. 4, in some implementations a plurality of batteries can be connected to form a module that includes a plurality of frames 110, a plurality of first current collectors 130a, and a plurality of second current collectors 130b (the examine of FIG. 4 shows an interconnection of 3 batteries). In some scenarios, the plurality of first current collectors 130a can be electrically connected (e.g., by a bus bar) to connect the plurality of batteries in parallel or series.

The first current collector 130a can include a first metal current collector 131a made of metal and electrically connected with the bus bar, and a first carbon current collector 132a can be disposed between the first metal current collector 131a and the frame 110 (as was shown in FIG. 3).

The first carbon current collector 132a can be made of a material such as graphite, carbon and carbon plastic, and can have high electrical conductivity and high acid resistance. Referring back to FIG. 3, the first carbon current collector 132a can be disposed between the first liquid electrode and the first metal current collector 131a to allow electrons to move between them, but to prevent the first metal current collector 131a from being oxidized. The first carbon current collector 132a can be formed in a rectangular plate shape or can be formed by applying the first metal current collector 131a.

The first carbon current collector 132a can be formed so that its outer peripheral portions (e.g., outer boundaries) match the outer peripheral portions (e.g., outer boundaries) of the frame 110. The first carbon current collector 132a can be bonded to the frame 110 by the first adhesive member 160a. The first carbon current collector 132a can have the first adhesive member 160a adhered or applied to its outer peripheral portions.

The first metal current collector 131a can be made of a metal with high electrical conductivity, for example, copper or aluminum. The first metal current collector 131a can be formed in a rectangular plate shape, and a part thereof can protrude to be connected to the bus bar.

The first metal current collector 131a can be formed of a flexible thin film or rigid plate. As shown in FIG. 4, when a plurality of batteries form a module, the plurality of first metal current collector 131a can be formed of a flexible thin film, with some part formed of a rigid plate.

The first carbon current collector 132a can be disposed on one surface of the first metal current collector 131a. When the plurality of batteries form the module as shown in FIG. 4, the first carbon current collector 132a of adjacent batteries on two opposite sides of a battery can be disposed on each of the two sides of the first metal current collector 131a of the battery.

Referring back to FIG. 3, the second current collector 130b can be disposed on the other side of the frame 110 to form the second electrode reservoir 111b together with the frame 110 and the separating membrane 120. The second current collector 130b can be in parallel and spaced apart from the first current collector 130a. The second current collector 130b can be adhered to the second adhesive member 160b adhered to the frame 110. The second current collector 130b can be bonded to the frame 110 by the second adhesive member 160b. For example, the second adhesive member 160b can be applied or adhered to the outer peripheral portion of the second current collector 130b and/or to the outer peripheral portion of the frame 110 to adhere the two together. The second current collector 130b can be electrically connected to the second liquid electrode and electrons can move so that current can flow when charging and discharging.

When the plurality of batteries form a module (e.g., as in FIG. 4) that includes the plurality of frames 110, the plurality of first current collectors 130a, and the plurality of second current collectors 130b, the plurality of second current collectors 130b can be electrically connected (e.g., by a bus bar) to connect the plurality of batteries in parallel.

The second current collector 130b can include a second metal current collector 131b made of metal and electrically connected with the bus bar; a second carbon current collector 132b disposed between the second metal current collector 131b and the frame 110.

The second carbon current collector 132b can be made of a material such as graphite, carbon and carbon plastic, and can have high electrical conductivity and high acid resistance. The second carbon current collector 132b can be disposed between the second liquid electrode and the second metal current collector 131b to allow electrons to move between them, but to prevent the second metal current collector 131b from being oxidized. The second carbon current collector 132b can be formed in a rectangular plate shape or can be formed by applying the second metal current collector 131b.

The second carbon current collector 132b can be formed so that its outer peripheral portions (e.g., outer boundaries) match the outer peripheral portions (e.g., outer boundaries) of the frame 110. The second carbon current collector 132b can be bonded to the frame 110 by the second adhesive member 160b. The second carbon current collector 132b can have the second adhesive member 160b adhered or applied to its outer peripheral portions.

The second metal current collector 131b can be made of a metal with high electrical conductivity, for example, copper or aluminum. The second metal current collector 131b can be formed in a rectangular plate shape, and a part thereof can protrude to be connected to the bus bar.

The second metal current collector 131b can be formed of a flexible thin film or rigid plate. As shown in FIG. 4, when the plurality of batteries form the module, the plurality of second metal current collector 131b can be formed of a flexible thin film, with some part formed of a rigid plate.

The second carbon current collector 132b can be disposed on one surface of the second metal current collector 131b. When the plurality of batteries form the module as shown in FIG. 4, the second carbon current collector 132b of adjacent batteries on two opposite sides of a battery can be disposed on each of the two sides of the second metal current collector 131b of the battery.

Referring back to FIG. 3, the first solid electrode 150a can be impregnated with the first liquid electrode and disposed in the first electrode reservoir 111a. The first solid electrode 150a can be surrounded by the frame 110, the first current collector 130a and the separating membrane 120. The first solid electrode 150a can include carbon-based materials such as carbon or graphite felt, carbon cloth, carbon black, graphite powder, or graphene. The first solid electrode 150a can be disposed further toward an interior of the frame 110 (in the in-plane direction) as compared to the first adhesive member 160a.

In some implementations, the first solid electrode 150a can be formed in a porous hexahedron shape. The first solid electrode 150a can have a thickness greater than the out-of-plane direction thickness of the first electrode reservoir 111a. In this case, the first solid electrode 150a can be accommodated by being pressed into the first electrode reservoir 111a. The first solid electrode 150a can be in close contact with the first current collector 130a and the separating membrane 120.

The second solid electrode 150b can be impregnated with the second liquid electrode and disposed in the second electrode reservoir 111b. The second solid electrode 150b can be surrounded by the frame 110, the second current collector 130b and the separating membrane 120. The second solid electrode 150b can include carbon-based materials such as carbon or graphite felt, carbon cloth, carbon black, graphite powder, or graphene. The second solid electrode 150b can be disposed further toward the interior of the frame 110 (in the in-plane direction) as compared to the second adhesive member 160b.

In some implementations, the second solid electrode 150b can be formed in a porous hexahedron shape. The second solid electrode 150b can have a thickness greater than the out-of-plane direction thickness of the second electrode reservoir 111b. In this case, the second solid electrode 150b can be accommodated by being pressed into the second electrode reservoir 111b. The second solid electrode 150b can be in close contact with the second current collector 130b and the separating membrane 120.

Each of the first adhesive member 160a and the second adhesive member 160b can include at least one of an acrylate-based adhesive, an acrylate-ester-based adhesive, an acrylate-ethylene-based adhesive, a polycarbonate-based adhesive, a polyethylene-based adhesive, and an epoxy-based adhesive and an isocyanate-based adhesive. Each of the first adhesive member 160a and the second adhesive member 160b is one or a combination of a solvent-based adhesive, an emulsion-based adhesive, a hot-melt-based adhesive, a liquid-curing-based adhesive, or a film-based adhesive.

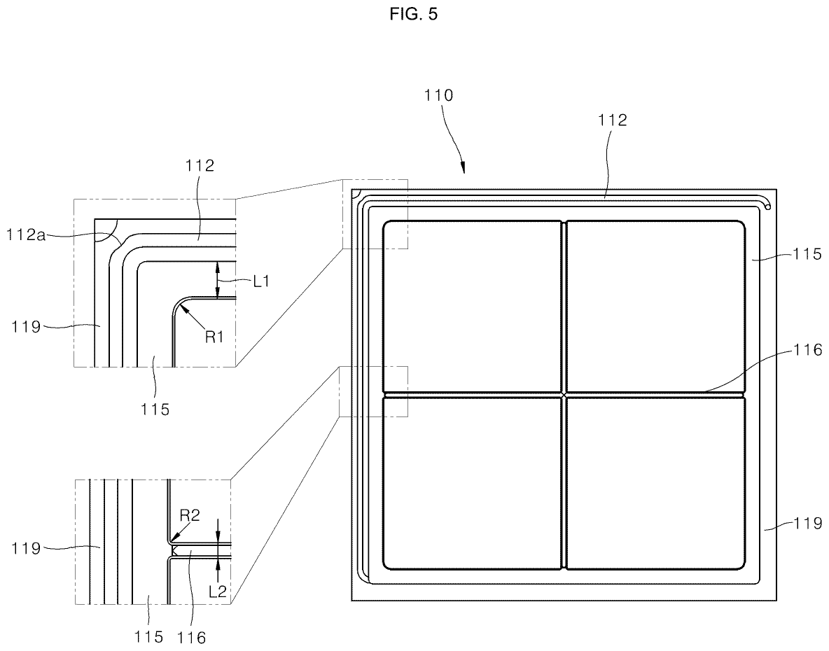

Each of the first adhesive member 160a and the second adhesive member 160b can be formed in a strip shape. For example, each of the first adhesive member 160a and the second adhesive member 160b can be formed in a square shape with a hollow interior region. In some implementations, each of the first adhesive member 160a and the second adhesive member 160b can be formed as a closed curve around a peripheral region of the frame, for example in a band shape as shown in the example of FIG. 5. In some implementations, the outer peripheral portions (e.g., outer boundaries) of each of the first adhesive member 160a and the second adhesive member 160b are formed to match the outer peripheral portions (e.g., outer boundaries) of the frame 110.

The first adhesive member 160a can bind the first carbon current collector 132a of the first current collector 130a to the frame 110. The first adhesive member 160a can seal between the first carbon current collector 132a of the first current collector 130a and the frame 110. The first adhesive member 160a can be layered between the first carbon current collector 132a of the first current collector 130a and the frame. The first adhesive member 160a can be adhered to one in-plane direction side of the frame 110. The first adhesive member 160a can be adhered to an outer peripheral portion of one surface of the first carbon current collector 132a on which the first metal current collector 131a is not disposed. The first adhesive member 160a can be applied on the first carbon current collector 132a to be adhesive to the frame 110.

The first adhesive member 160a can be disposed to allow the outer peripheral portions (e.g., outer boundaries) of the first carbon current collector 132a of the first current collector 130a to match the outer peripheral portions (e.g., outer boundaries) of the frame 110. The first adhesive member 160a can be disposed further toward the outer boundary of the frame 110 (in the in-plane direction) as compared to the first solid electrode 150a. The first adhesive member 160a can be disposed further toward the outer boundary of the frame 110 (in the in-plane direction) as compared to the first reservoir 111a. The first adhesive member 160a can be disposed further toward the outer boundary of the frame 110 (in the in-plane direction) as compared to the separating membrane 120.

The second adhesive member 160b can bind the second carbon current collector 132b of the second current collector 130b to the frame 110. The second adhesive member 160b can seal between the second carbon current collector 132b of the second current collector 130b and the frame 110. The second adhesive member 160b can be layered between the second carbon current collector 132b of the second current collector 130b and the frame 110. The second adhesive member 160b can be adhered to the other out-of-plane direction outer peripheral portion of the frame 110. The second adhesive member 160b can be adhered to the outer peripheral portion of one of the two surfaces of the second carbon current collector 132b, where the second metal current collector 131b is not disposed. The second adhesive member 160b can be applied to the second carbon current collector 132b to be adhesive to the frame 110.

The second adhesive member 160b can be disposed to allow the outer peripheral portions (e.g., outer boundaries) of the second carbon current collector 132b of the second current collector 130b to match the outer peripheral portions (e.g., outer boundaries) of the frame 110. The second adhesive member 160b can be disposed further toward the outer boundary of the frame 110 (in the in-plane direction) as compared to the second solid electrode 150b. The second adhesive member 160b can be disposed further toward the outer boundary of the frame 110 (in the in-plane direction) as compared to the second reservoir 111b. The second adhesive member 160b can be disposed further toward the outer boundary of the frame 110 (in the in-plane direction) as compared to the separating membrane 120.

The structure of the battery having the above-noted configurations according to the present disclosure will be described as follows.

The separating membrane 120 can be bonded to the thickness-direction center of the rectangular frame 110 with a predetermined thickness. The first current collector 130a can be bonded to one out-of-plane direction side of the frame 110 by the first adhesive member 160a, and the second current collector 130b can be bonded to the other out-of-plane direction side of the frame by the second adhesive member 160b, only to form the first electrode reservoir 111a and the second electrode reservoir 111b. That is, the frame 110 can be disposed between the first current collector 130a and the second current collector 130b, and the separating membrane 120 can be disposed in the frame 110.

The first solid electrode 150a impregnated with the first liquid electrode can be disposed in the first electrode reservoir 111a, and the second solid electrode 150b impregnated with the second liquid electrode can be disposed in the second electrode reservoir 111b.

The first adhesive member 160a or the second adhesive member 160b can be adhered to the outer peripheral regions of the frame 110 to be adhered to the outer peripheral regions of the first carbon current collector 132a or the second carbon current collector 132b. The first adhesive member 160a, the second adhesive member 160b, the frame 110, the first carbon current collector 132a and the second carbon current collector 132b can be disposed to allow the outer peripheral regions (e.g., outer boundaries) thereof to match each other. Accordingly, when they are bonded to each other, the shape becomes a rectangular parallelepiped shape.

Referring to FIG. 4, the above-described configurations are crossed and repeated to form the module. That is, the first current collector 130a can be disposed between the plurality of frames 110 to which the separating membrane 120 is bonded, and the second current collector 130b can be disposed between the plurality of frames 110 to which the separating membrane 120 is bonded. In this case, only one first metal current collector 131a can be disposed between two first carbon current collectors 132a, and only one second metal current collector 131b can be disposed between two second carbon current collector 132b.

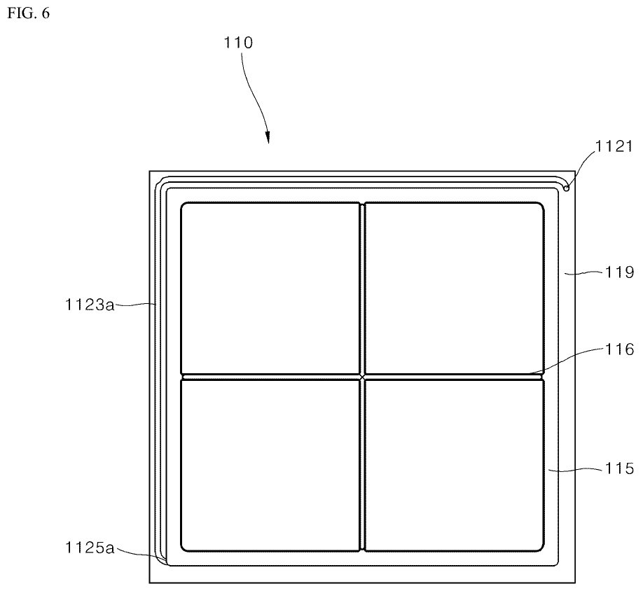

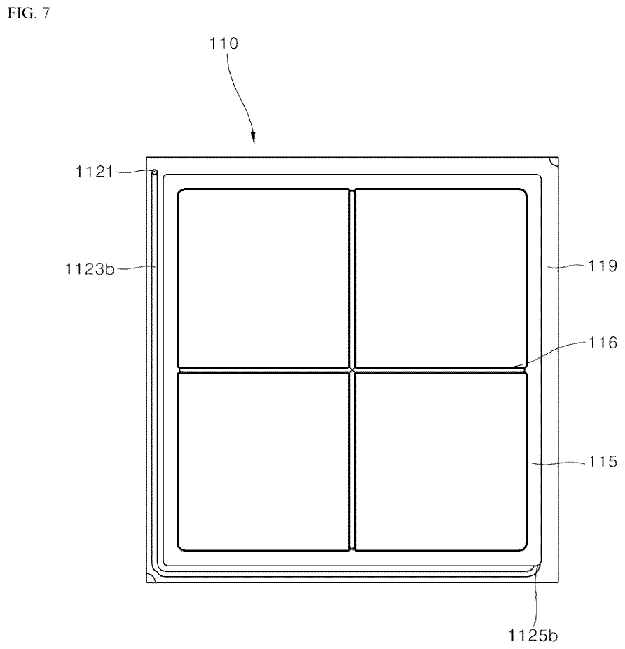

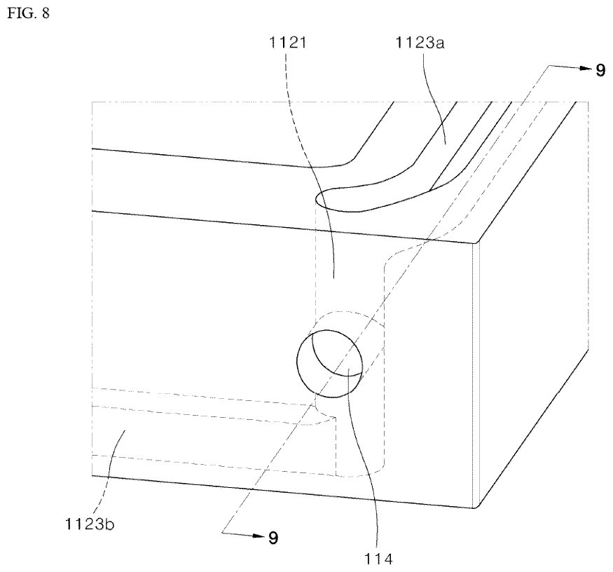

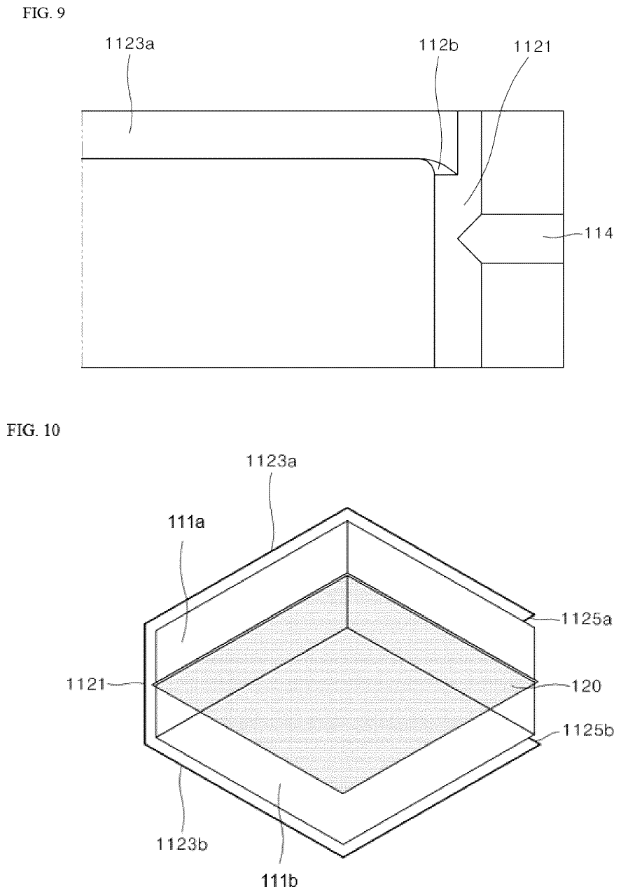

FIG. 5 is a plane view of an example of a frame according to an implementation. FIG. 6 is a front view of an example of a frame according to an implementation. FIG. 7 is a rear view of an example of a frame according to an implementation. FIG. 8 is a transparent perspective view of a portion of an example of a frame according to an implementation. FIG. 9 is a cross sectional view of an example of the frame shown in FIG. 8 along a 9-9 direction. FIG. 10 is a structural diagram of an inter-electrode communication part according to an implementation.

The frame 110 according to an implementation of the present disclosure can include a frame body 119 having a square shape with an outer structural region that surrounds a hollow interior region; a separating membrane supporter 115 protruding inward from the outer structural region of the frame body 119 toward the hollow interior region to be bonded to the separating membrane 120; and a frame reinforcing portion 116 disposed in the hollow interior region of the frame body 119 to prevent deformation of the frame body 119.

The frame body 119 can be formed in the hollow square shape with four bars. The hollow interior region of the frame body 119 can form the first electrode reservoir 111a and the second electrode reservoir 111b. The separating membrane supporter 115 protruding in the in-plane direction can be formed in the hollow interior region of the frame body 119. The inter-electrode communication part 112 can be formed in the frame body 119.

The frame body 119 can have one out-of-plane direction side to which the first adhesive member 160a is adhered and the other out-of-plane direction side to which the second adhesive member 160b is adhered. The out-of-plane direction side of the frame body 119 can be bonded to the first current collector 130a by the first adhesive member 160a, and the other out-of-plane direction side thereof can be bonded to the second current collector 130b by the second adhesive member 160b.

The separating membrane supporter 115 can protrude toward the center in the in-plane direction from the hollow interior region of the frame body 119, and can be formed in a square shape. Referring to FIG. 3, the separating membrane supporter 115 can be disposed at the center of the frame body 119 in the thickness direction.

The outer peripheral portion of the separating membrane 120 can be bonded to the separating membrane supporter 115 so that the separating membrane can be stretched tightly. It is preferred that the separating membrane supporter 115 has a minimum width L1 capable of supporting the separating membrane 120 (as shown in FIG. 5). The separating membrane supporter 115 can serve as a rib for reinforcing the in-plane direction of the frame body 119, to prevent the frame body 119 from being deformed in the in-plane direction even when expansion or contraction of the first or second liquid electrode, gas generation within the liquid electrode or external shock occurs.

One lateral surface of the separating membrane supporter 115 can be bonded to the separating membrane 120 in close contact, to prevent the first liquid electrode or second liquid electrode from leaking between the separating membrane supporter 115 and the separating membrane 120. An adhesive including the same component as the material of the first adhesive member 160a or second adhesive member 160b can be disposed between the between the separating membrane supporter 115 and the separating membrane 120. The separating membrane supporter 115 and the separating membrane 120 can be bonded by an adhesive including at least one of an n acrylate-based adhesive, an acrylate-ester adhesive, an acrylate-ethylene-based adhesive, a polycarbonate-based adhesive, a polyethylene-based adhesive, an epoxy-based adhesive, and an isocyanate-based adhesive.

As shown in FIG. 5, the separating membrane supporter 115 has an inner rounded corner forming the hollow interior region. The width L1 of the separating membrane supporter 115 is equal to the radius R1 of the inner rounded corner.

The frame reinforcing portion 116 can be formed to connect one side of the separating membrane supporter 115 to another side or to connect one vertex to another vertex. The frame reinforcing portion 116 of this implementation can be formed in a + shape connecting two opposite sides of the frame body 119.

The frame reinforcing portion 116 can be disposed across the separating membrane 120. In such scenarios, a width L2 (i.e., thickness in the in-plane direction) of the frame reinforcing portion 116 can be formed as small as possible to facilitate and minimize obstruction of cation migration through the separating membrane 120. As shown in the example of FIG. 5, the width L2 of the frame reinforcing portion 116 can be smaller than the width L1 (i.e., thickness in the in-plane direction) of the separating membrane supporter 115. In some implementations, the width L2 of the frame reinforcing portion 116 is smaller than the radius of curvature R1 of the inner rounded corner of the separating membrane supporter 115.

In some scenarios, the frame reinforcing portion 116 can have a rounded corner connected to the separating membrane supporter 115. In some implementations, the radius of curvature R2 of the rounded corner of the frame reinforcing portion 116 can be formed as small as possible to facilitate and minimize obstruction of cation migration through the separating membrane 120. For example, the radius of curvature R2 of the rounded corner of the frame reinforcing portion 116 can be smaller than the radius of curvature R1 of the inner rounded corner of the separating membrane supporter 115. Also, in some implementations, the width L2 of the frame reinforcing portion 116 can be larger than the radius of curvature R2 of the rounded corner of the frame reinforcing portion 116.

The battery according to some implementations may further include an inter-electrode communication part 112 to be in fluidic communication with the first electrode reservoir 111a and the second electrode reservoir 111b; and an injection hole 114 formed in the frame 110 so that the first liquid electrode or second liquid electrode may be injected through the injection hole 114.

The first liquid electrode and/or the second liquid electrode can flow in the inter-electrode communication part 112. The separating membrane 120 prevents the first liquid electrode and the second liquid electrode from mixing with each other, but when charging or discharging, the vanadium ions and water contained in the first liquid electrode and the second liquid electrode might penetrate the separating membrane, which means that ‘crossover phenomenon’ might occur. Accordingly, an imbalance occurs in the amount of the first liquid electrode and the amount of the second liquid electrode, which affects the performance and lifespan of the battery. If a liquid electrode tank and a pump are provided like in the conventional redox secondary battery, this imbalance of the liquid electrodes could be resolved. However, when the small amount of liquid electrode exists only inside the battery as in the present disclosure, even small imbalance might affect the performance and lifespan of the battery. The inter-electrode communication part 112 can be configured to resolve the imbalance caused by this crossover, and can allow the first liquid electrode or second liquid electrode with an increased volume to be temporarily stored in the inter-electrode communication part 112 or to be moved to the first liquid electrode or second liquid electrode with a reduced volume through the inter-electrode communication part 112.

To resolve the imbalance between the amount of the first liquid electrode and the amount of the second liquid electrode due to crossover that might occur when charging or discharging, the inter-electrode communication part 112 is configured to be in fluidic communication with the first electrode reservoir 111a and the second electrode reservoir 111b so that the first liquid electrode or second liquid electrode can flow inside the inter-electrode communication part, when charging or discharging.

The inter-electrode communication part 112 can be formed thin and long to have a resistance value above a predetermined level while having a volume allowing flow of as much as half the difference between the amount of the first liquid electrode and the amount of the second liquid electrode due to the crossover.

At least a portion of the inter-electrode communication part 112 is formed in a direction penetrating the plane formed by the separating membrane 120 (in the out-of-plane direction).

The portion, formed in a direction penetrating the plane formed by the separating membrane 120, of the inter-electrode communication part 112 is disposed at the center of the inter-electrode communication part 112.

In some implementations, the inter-electrode communication part 112 can be bent at least twice. For example, the inter-electrode communication part 112 can having a first bent portion that is bent from an in-plane direction of the frame 110 to an out-of-plane direction (or from an out-of-plane direction to an in-plane direction) of the frame 110, and can also have a second bent portion that is bent along an in-plane direction of the frame 110.

In some scenarios the second bent portion of the inter-electrode communication part 112 that is bent along the in-plane direction of the frame 110 can further have a bent protrusion 112a that protrudes inward in a direction toward the separating membrane 120. This bent protrusion 112a can have various beneficial effects. For example, because the liquid electrode typically has dissolved gas inside, when the liquid electrode flows through the second bent portion of the inter-electrode communication part 112 that bends along the in-plane direction of the frame 110, the dissolved gas could be released due to a difference in the flow rates of the liquid electrode that flows along the outer curvature of the second bent portion as compared to the liquid electrode that flows along the inner curvature of the second bent portion. Such a release of dissolved gas can be mitigated by implementing the bent protrusion 112a which causes the second bent portion of the inter-electrode communication part 112 to protrude inward.

In some scenarios, the first bent portion of the inter-electrode communication part 112 that is bent from the in-plane direction to the out-of-plane direction (or from the out-of-plane direction to the in-plane direction) can be formed as a curved surface 112b on the inside. In scenarios where the inter-electrode communication part 112 is formed relatively short in the out-of-plane direction, it is preferable that the inside of the first bent portion is formed as the curved surface 112b in order for the first liquid electrode or the second liquid electrode to flow smoothly through the first bent portion.

The inter-electrode communication part 112 can be formed in a part of the frame body 119 surrounding the first solid electrode 150a or second solid electrode 150b to be disposed in a part of the circumference of the first solid electrode 150a or second solid electrode 150b.

In some implementations, the inter-electrode communication part 112 can be disposed further toward the outer boundary of the frame 110 (in the in-plane direction) as compared to the separating membrane supporter 115. In some implementations, the inter-electrode communication part 112 may be disposed further inward away from the outer boundary of the frame 110 (in the in-plane direction) as compared to the adhesive member 160a or second adhesive member 160b. For example, the inter-electrode communication part 112 can be covered by the first adhesive member 160a or second adhesive member 160b.

Referring to FIGS. 6 and 7, the inter-electrode communication part 112 can include an inter-electrode through-hole 1121 formed as a through-hole in the frame 110 in the out-of-plane direction; a first inter-electrode channel 1123a through which the inter-electrode through-hole 1121 and the first electrode reservoir 111a are in fluidic communication with each other; and a second inter-electrode channel 1123b through which the inter-electrode through-hole 1121 and the second electrode reservoir 111b are in fluidic communication with each other.

The inter-electrode through-hole 1121 is a hole formed by penetrating the frame body 119 in the out-of-plane direction. The inter-electrode through-hole 1121 can be disposed in a direction penetrating the plane formed by the separating membrane 120. The inter-electrode through-hole 1121 can be perpendicular to the plane formed by the separating membrane 120. One end of the inter-electrode through-hole 1121 can be perpendicular to the first inter-electrode channel 1123a and the other end of the inter-electrode through-hole 1121 can be perpendicular to the second inter-electrode channel 1123b. Referring to the examples of FIG. 8 and FIG. 9, a portion of the inter-electrode through-hole 1121 that connects with the first inter-electrode channel 1123a and/or the second inter-electrode channel 1123b is formed as a curved surface 112b. In some implementations, the inner side of the portion where the inter-electrode through-hole 1121 and the first inter-electrode channel 1123a meet (e.g., at an orthogonal angle) and/or the inner side of the portion where the inter-electrode through-hole 1121 and the second inter-electrode channel 1123b meet (e.g., at an orthogonal angle) is formed by the curved surface 112b.

The inter-electrode through-hole 1121 formed in the out-of-plane direction can be bent in the in-plane direction at one end to be connected to the first inter-electrode channel 1123a, and bent in the in-plane direction at the other end to be connected with the second inter-electrode channel 1123b. The inter-electrode through-hole 1121 can connect the first inter-electrode channel 1123a and the second inter-electrode channel 1123b with each other.

The inter-electrode through-hole 1121 can be formed in a region of one corner of the square-shaped frame body 119. Due to the molding process of the frame 110, in some scenarios it may be difficult to form the inter-electrode through-hole 1121 exactly at the corners of the frame body 119, in which case the inter-electrode through-hole 1121 is formed as close to the corners as possible.

One end of the inter-electrode through-hole 1121 can be covered by the first adhesive member 160a and the other end thereof can be covered by the second adhesive member 160b. The out-of-plane direction (i.e., longitudinal direction) center of the inter-electrode through-hole 1121 can be connected with an injection hole 114, which will be described later.

Referring to FIG. 6, the first inter-electrode channel 1123a can be formed in one out-of-plane direction side of the frame body 119 as the groove. The first inter-electrode channel 1123a can be formed along the frame body 119 as making the in-plane direction as the longitudinal direction. The first inter-electrode channel 1123a is disposed further toward the outer boundary of the frame body 119 as compared to the first solid electrode 150a.

The first inter-electrode channel 1123a can be bent at least one time in the in-plane direction. For example, the first inter-electrode channel 1123a is formed lengthwise along one side of the frame body 119 at the inter-electrode through-hole 1121 and then bends once (e.g., at a right angle) at a corner of the frame body 119 to form lengthwise along the other side of the frame body 119. More specifically, in some implementations, the first inter-electrode channel 1123a is formed in an L-shape in the inter-electrode through-hole 1121 and is connected to the first electrode reservoir 111a. The first inter-electrode channel 1123a may be bent once (e.g., at a right angle), as well as bent where it connects with the inter-electrode through-hole 1121 or where it connects with the first electrode reservoir 111a.

The first inter-electrode channel 1123a connects with the first electrode reservoir 111a near one of the corners of the frame body 119 (e.g., the corner opposite the corner in which the inter-electrode through-hole 1121 is formed), and in some implementations, the first inter-electrode channel 1123a has a length from the inter-electrode through-hole 1121 to the bent portion and a length from the bent portion to the connection with the first electrode reservoir 111a that are substantially the same.

Referring to FIG. 5, as discussed above, the first inter-electrode channel 1123a has the bent protrusion 112a that protrudes inwardly from an outer side of the bent portion. For example, the bent protrusion 112a protrudes inwardly from an outer side of the bent portion of the first inter-electrode channel 1123a to inhibit dissolved gas release.

In some implementations, the first inter-electrode channel 1123a is formed on two bars of the frame body 119. The first inter-electrode channel 1123a is formed with a first inter-electrode drain 1125a that is open to connect and enable fluidic communication with the first electrode reservoir 111a. For example, the first inter-electrode drain 1125a can be formed near one of the corners of the frame body 119 (e.g., a corner opposite the corner in which the inter-electrode through-hole 1121 is formed). The first inter-electrode channel 1123a can be covered by the first adhesive member 160a.

Referring to FIG. 7, the second inter-electrode channel 1123b can be formed in one out-of-plane direction side of the frame body 119 as the groove. The second inter-electrode channel 1123b can be formed along the frame body 119 as making the in-plane direction as the longitudinal direction. The second inter-electrode channel 1123b is disposed further toward the outer boundary of the frame body 119 as compared to the second solid electrode 150b.

The second inter-electrode channel 1123b can be bent at least one time in the in-plane direction. For example, the second inter-electrode channel 1123b is formed lengthwise along one side of the frame body 119 at the inter-electrode through-hole 1121 and then bends once (e.g., at a right angle) at a corner of the frame body 119 to form lengthwise along the other side of the frame body 119. More specifically, in some implementations, the second inter-electrode channel 1123b is formed in an L-shape in the inter-electrode through-hole 1121 and is connected to the second electrode reservoir 111b. The second inter-electrode channel 1123b may be bent once (e.g., at a right angle), as well as bent where it connects with the inter-electrode through-hole 1121 or where it connects with the second electrode reservoir 111b.

The second inter-electrode channel 1123b connects with the second electrode reservoir 111b near one of the corners of the frame body 119 (e.g., the corner opposite the corner in which the inter-electrode through-hole 1121 is formed), and in some implementations, the second inter-electrode channel 1123b has a length from the inter-electrode through-hole 1121 to the bent portion and a length from the bent portion to the connection with the second electrode reservoir 111b that are substantially the same.

Like the first inter-electrode channel 1123a, and as discussed above, the second inter-electrode channel 1123b has the bent protrusion 112a that protrudes inwardly from an outer side of the bent portion. For example, the bent protrusion 112a protrudes inwardly from an outer side of the bent portion of the second inter-electrode channel 1123b to inhibit dissolved gas release.

In some implementations, the second inter-electrode channel 1123b is formed with a second inter-electrode drain 1125b that is open to connect and enable fluidic communication with the second electrode reservoir 111b. The second inter-electrode drain 1125b is formed near one of the corners of the frame body 119 (e.g., a corner opposite the corner in which the inter-electrode through-hole 1121 is formed). The second inter-electrode channel 1123b can be covered by the second adhesive member 160b.

In scenarios where the first inter-electrode channel 1123a and the second inter-electrode channel 1123b are formed as grooves in the frame body 119, they affect the strength of the frame body 119. Therefore, in some implementations, the first inter-electrode channel 1123a and the second inter-electrode channel 1123b are preferably not formed in the same portion of the frame body 119, for example, the first inter-electrode channel 1123a can be formed in a portion of the frame body 119 where the second inter-electrode channel 1123b is not formed. In some scenarios, the first inter-electrode channel 1123a is formed on two sides of the frame (e.g., two bars of the frame body 119), and the second inter-electrode channel 1123b is formed on the opposing two sides of the frame (e.g., the other two bars of the frame body 119) where the first inter-electrode channel 1123a is not formed.

The above-described structure can enable the first inter-electrode channel 1123a to be substantially symmetrical with the second inter-electrode channel 1123b with respect to the center of the frame 110. In scenarios where the inter-electrode through-holes 1121 are not formed exactly at the corners of the frame body 119 (e.g., due to the molding process of the frame 110), the first inter-electrode channel 1123a and the second inter-electrode channel 1123b are substantially symmetrical, even though they are not perfectly symmetrical. In some implementations, the first inter-electrode channel 1123a does not overlap with the second inter-electrode channel 1123b when projected in the thickness direction (out-of-plane direction) of the frame 110.

To facilitate movement of the first liquid electrode or the second liquid electrode through the inter-electrode communication part 112 in a balanced manner, in some implementations the inter-electrode communication part 112 is preferably formed in such a way that the part connected with the first electrode reservoir 111a and the part connected with the second electrode reservoir 111b are of the same volume. In such implementations, the inter-electrode through-hole 1121 is preferably formed in the center of the inter-electrode communication part 112, for example, the first inter-electrode channel 1123a has substantially the same volume as the second inter-electrode channel 1123b. In scenarios where the molding process of the frame 110 makes it difficult to form the inter-electrode through-holes 1121 exactly at the corners of the frame body 119, the first inter-electrode channel 1123a and the second inter-electrode channel 1123b can be substantially the same in volume, if not completely the same. Further, the first inter-electrode channel 1123a can be substantially the same length as the second inter-electrode channel 1123b.

The injection hole 114 can be formed in the frame 110 so that the liquid electrode can be injected from the outside through the injection hole 114 to be introduced into the first electrode reservoir 111a and the second electrode reservoir 111b. The injection hole 114 can have one end that is open to the outside in the frame 110. The injection hole 114 can be formed to inject the first liquid electrode into the first electrode reservoir 111a and the second liquid electrode into the second electrode reservoir 111b. When the liquid electrode is injected from the outside through the injection hole 114, the liquid electrode can be accommodated in the first electrode reservoir 111a and the second electrode reservoir 111b. The liquid electrode injected into the first electrode reservoir 111a through the injection hole 114 can become the first liquid electrode, and the liquid electrode injected into the second electrode reservoir through the injection hole 114 can become the second liquid electrode.

The injection hole 114 can be the hole formed in the in-plane direction of the frame 110. The injection hole 114 can be formed at one end of one bar of the frame body 119 in a longitudinal direction. The injection hole 114 can be formed at one corner of the square-shaped frame body 119. The injection hole 114 can be formed at the thickness direction of the frame body 119.

In some implementations, the injection hole 114 can be disposed on the plane formed by the separating membrane 120. For example, the injection hole 114 can be orthogonally connected to the inter-electrode through-hole 1121 of the inter-electrode communication part 112. The injection hole 114 can branch into the inter-electrode communication part 112 and can be connected with the first electrode reservoir 111a and the second electrode reservoir 111b. In some scenarios, the injection hole 114 is connected to the center of the inter-electrode through-hole 1121 in the out-of-plane direction (longitudinal direction). The injection hole 114 can be disposed between the first inter-electrode channel 1123a and the second inter-electrode channel 1123b.

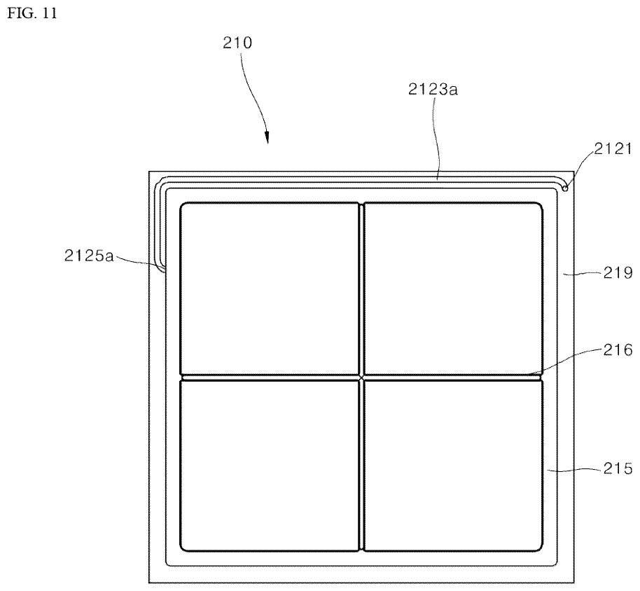

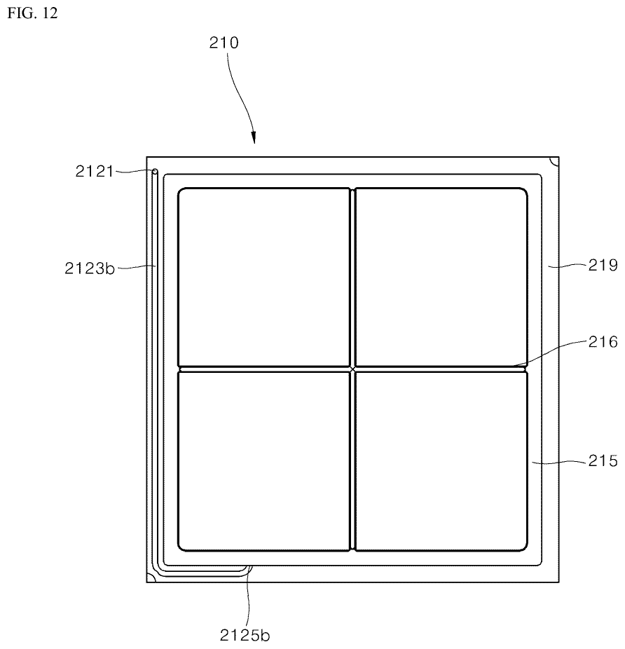

FIG. 11 is a front view of an example of a frame according to another implementation. FIG. 12 is a rear view of an example of a frame according to another implementation.

Details of the battery according to the implementations of FIGS. 11 and 12 that are identical to details of the implementations of the battery described above will not be described, except for the frame 210.

In particular, details of the frame body 219, separating membrane supporter 215, and frame reinforcing portion 216 of the frame 210 of the battery according to the implementations of FIGS. 11 and 12 are identical to details of the frame body 119, separating membrane supporter 115, and frame reinforcing portion 116 of the frame 110 of implementations of the battery described above, and are therefore omitted from the description of FIGS. 11 and 12.

In addition, details of the inter-electrode through-hole 2121 of the battery according to the implementations of FIGS. 11 and 12 are also identical to details of the inter-electrode through-hole 1121 of implementations of the battery described above, and will not be described.

The first transition line 2123a of the battery according to the implementations of FIGS. 11 and 12 can be shorter in length than the first transition line 1123a of implementations of the battery described above.

The first inter-electrode channel 2123a of the battery according to implementations of FIGS. 11 and 12 can be formed in an L-shape by bending once (e.g., at a right angle) along the shape of the frame body 219 at the inter-electrode through-hole 2121 to form an L-shape, and can then connect with the first electrode reservoir 111a at one side of the frame body 219 (e.g., one bar of the frame body 219). As such, the first inter-electrode drain 2125a can be formed on one side of the frame body 219. The first inter-electrode channel 2123a can have a length from the inter-electrode through-hole 2121 to the bent portion that is longer than the length from the bent portion to the portion connecting with the first electrode reservoir 111a.

The second transition line 2123b of the battery according to implementations of FIGS. 11 and 12 can be shorter in length than the second transition line 1123b of implementations of the battery described above.

The second inter-electrode channel 2123b of the battery according to the implementations of FIGS. 11 and 12 can be formed in an L-shape by bending once (e.g., at a right angle) along the shape of the frame body 219 at the inter-electrode through-hole 2121 to form an L-shape, and can then connect with the second electrode reservoir 111b at one side of the frame body 219 (e.g., one bar of the frame body 219). As such, the second inter-electrode drain 2125b can be formed on one side of the frame body 219. The second inter-electrode channel 2123b can have a length from the inter-electrode through-hole 2121 to the bent portion that is longer than the length from the bent portion to the portion connecting with the second electrode reservoir 111b.

In the battery according to implementations of FIGS. 11 and 12, the first inter-electrode channel 2123a or the second inter-electrode channel 2123b can be connected to the first electrode reservoir 111a or the second electrode reservoir 111b at a side of the frame 210, As such, the first inter-electrode drain 2125a or the second inter-electrode drain 2125b can be formed on a side other than a corner of the frame 210. This can help prevent weakening of the strength of the corners of the frame 210, where stresses are concentrated. Additionally, flow resistance can be lowered by reducing bends in the first inter-electrode channel 2123a or the second inter-electrode channel 2123b.

In the battery according to implementations of FIGS. 11 and 12, the first inter-electrode channel 2123a or the second inter-electrode channel 2123b can be formed with a relatively long length from the inter-electrode through-hole 2121 to the bent portion, for example to preferably delay the mixing of the first liquid electrode or the second liquid electrode flowing through the first inter-electrode channel 2123a or the second inter-electrode channel 2123b with the first liquid electrode or the second liquid electrode having opposite electrodes. As such, although the first liquid electrode or second liquid electrode with increased volume can easily flow into the first transition line 2123a or the second transition line 2123b, it is preferably delayed from flowing to the opposite side through the inter-electrode through-hole 2121.

The implementations are described above with reference to a number of illustrative implementations thereof. However, the present disclosure is not intended to limit the implementations and drawings set forth herein, and numerous other modifications and implementations can be devised by one skilled in the art. Further, the effects and predictable effects based on the configurations in the disclosure are to be included within the range of the disclosure though not explicitly described in the description of the implementations.

1. A battery comprising:
a first liquid electrode to undergo a first half reaction;
a second liquid electrode to undergo a second half reaction;
a frame that forms a first electrode reservoir in which the first liquid electrode is stored, and forms a second electrode reservoir in which the second liquid electrode is stored;
a separating membrane disposed between the first electrode reservoir and the second electrode reservoir;
an inter-electrode through-hole formed at the frame along an out-of-plane direction of the frame;
a first inter-electrode channel connecting the inter-electrode through-hole and the first electrode reservoir; and
a second inter-electrode channel connecting the inter-electrode through-hole and the second electrode reservoir.

2. The battery of claim 1, wherein the first inter-electrode channel and the second inter-electrode channel are arranged on opposing sides of the frame in a substantially symmetrical arrangement with respect to the center of the frame.

3. The battery of claim 1, wherein the first inter-electrode channel does not overlap with the second inter-electrode channel when projected in an out of plane direction of the frame.

4. The battery of claim 1, wherein the first inter-electrode channel is formed in a portion of the frame where the second inter-electrode channel is not formed.

5. The battery of claim 1, wherein the frame has a rectangular shape with a hollow interior region, and
wherein the first inter-electrode channel is formed on two sides of the frame, and the second inter-electrode channel is formed on other two sides of the frame where the first inter-electrode channel is not formed.

6. The battery of claim 1, wherein a volume of the first inter-electrode channel is substantially the same as a volume of the second inter-electrode channel.

7. The battery of claim 1, wherein a length of the first inter-electrode channel is substantially the same as a length of the second inter-electrode channel.

8. The battery of claim 1, wherein the first inter-electrode channel or the second inter-electrode channel comprises a bent portion that is bent at least one time in an in-plane direction of the frame.

9. The battery of claim 8, wherein the bent portion of the first inter-electrode channel or the second inter-electrode channel has a bent protrusion that protrudes inwardly toward an interior region of the frame.

10. The battery of claim 8, wherein the first inter-electrode channel or the second inter-electrode channel connects with the first electrode reservoir or the second electrode reservoir at a corner region of the frame.

11. The battery of claim 8, wherein the first inter-electrode channel or the second inter-electrode channel has a length from the inter-electrode through-hole to the bent portion that is substantially the same as a length from the bent portion to a connection with the first electrode reservoir or the second electrode reservoir.

12. The battery of claim 8, wherein the first inter-electrode channel or the second inter-electrode channel is connected to the first electrode reservoir or the second electrode reservoir at a side of the frame.

13. The battery of claim 8, wherein the first inter-electrode channel or the second inter-electrode channel has a length from the inter-electrode through-hole to the bent portion that is longer than a length from the bent portion to a portion of the first inter-electrode channel or the second inter-electrode channel that connects with the first or second electrode reservoir.

14. The battery of claim 1, wherein the first inter-electrode channel or the second inter-electrode channel is formed at the frame as a groove.

15. The battery of claim 1, wherein the inter-electrode through-hole is a hole formed by penetrating the frame.

16. The battery of claim 1, further comprising:
a first solid electrode disposed in the first electrode reservoir and configured to be impregnated with a first liquid electrode; and
a second solid electrode disposed in the second electrode reservoir and configured to be impregnated with a second liquid electrode,
wherein the first inter-electrode channel is disposed further toward an outer boundary of the frame as compared to the first solid electrode, and
the second inter-electrode channel is disposed further toward the outer boundary of the frame as compared to the second solid electrode.

17. The battery of claim 1, wherein a portion of the inter-electrode through-hole that connects with the first inter-electrode channel and/or the second inter-electrode channel is formed as a curved surface.

18. The battery of claim 1, further comprising:
an injection hole through which the first liquid electrode or second liquid electrode are injected to be introduced into the first electrode reservoir and the second electrode reservoir,
wherein the injection hole is connected to the inter-electrode through-hole.

19. The battery of claim 1, wherein the frame comprises a separating membrane supporter protruding inward from an outer structural region of the frame toward a hollow interior region of the frame and configured to be bonded to the separating membrane, and
a thickness of the separating membrane supporter in an in-plane direction of the frame is equal to a radius of curvature of an inner rounded corner of the separating membrane supporter.

20. The battery of claim 19, wherein the frame further comprises a frame reinforcing portion formed to connect one side of the separating membrane supporter to another side of the separating membrane supporter, and
a thickness of the frame reinforcing portion in the in-plane direction of the frame is smaller than the thickness of the separating membrane supporter in the in-plane direction of the frame.

21. The battery of claim 20, wherein the thickness of the frame reinforcing portion in the in-plane direction of the frame is smaller than the radius of curvature of the inner rounded corner of the separating membrane supporter.

22. The battery of claim 20, wherein a radius of curvature of a rounded corner of the frame reinforcing portion is smaller than the radius of curvature of the inner rounded corner of the separating membrane supporter.

23. The battery of claim 20, wherein the thickness of the frame reinforcing portion in the in-plane direction of the frame is larger than a radius of curvature of a rounded corner of the frame reinforcing portion.

24. A battery comprising:
a first current collector;
a second current collector spaced apart from the first current collector;
a separating membrane disposed between the first current collector and the second current collector;
a frame that forms a first electrode reservoir between the first current collector and the separating membrane, and forms a second electrode reservoir between the second current collector and the separating membrane;
an inter-electrode through-hole formed at the frame along an out of plane direction of the frame;
a first inter-electrode channel connecting the inter-electrode through-hole and the first electrode reservoir; and
a second inter-electrode channel connecting the inter-electrode through-hole and the second electrode reservoir.

25. A battery comprising:
a first liquid electrode to undergo a first half reaction;
a second liquid electrode to undergo a second half reaction;
a frame that forms a first electrode reservoir in which the first liquid electrode is stored, and forms a second electrode reservoir in which the second liquid electrode is stored;
a separating membrane disposed between the first electrode reservoir and the second electrode reservoir; and
an inter-electrode communication part that allows the first electrode reservoir and the second electrode reservoir to be in fluidic communication with each other,
wherein a portion, formed in a direction penetrating a plane formed by the separating membrane, of the inter-electrode communication part is disposed at the center of the inter-electrode communication part.

26. A battery comprising:
a first liquid electrode to undergo a first half reaction;
a second liquid electrode to undergo a second half reaction;
a separating membrane disposed between the first liquid electrode and the second liquid electrode;
a frame to support the separating membrane; and
an inter-electrode communication part in which the first liquid electrode and/or the second liquid electrode flows,
wherein a portion, formed in a direction penetrating a plane formed by the separating membrane, of the inter-electrode communication part is disposed at the center of the inter-electrode communication part.

27. A battery comprising:
a frame that forms (i) a first electrode reservoir configured to store a first liquid electrode to undergo a first half reaction, and (ii) a second electrode reservoir configured to store a second liquid electrode to undergo a second half reaction; and
a separating membrane that is supported by the frame to be disposed between the first electrode reservoir and the second electrode reservoir,
wherein the frame further comprises means for providing fluidic communication between the first electrode reservoir and the second electrode reservoir and injecting the first liquid electrode and the second liquid electrode into the first electrode reservoir and the second electrode reservoir.
